(19) United States
(12) Patent Application Publication
(10) Pub. No.: US 2019/0149691 A1
(43) Pub. Date: May 16, 2019

(54) INFORMATION PROCESSING APPARATUS, INFORMATION PROCESSING METHOD, AND INFORMATION PROCESSING PROGRAM

(71) Applicant: SHARP KABUSHIKI KAISHA, Sakai City (JP)

(72) Inventor: MASANORI HAMAMOTO, Sakai City (JP)

(21) Appl. No.: 16/184,586

(22) Filed: Nov. 8, 2018

(30) Foreign Application Priority Data
Nov. 10, 2017 (JP) 2017-217344

(51) Int. Cl. H04N 1/327; H04N 1/32

(52) U.S. Cl. CPC H04N 1/32771; H04N 2201/0094; H04N 1/32678; H04N 1/32539

(57) ABSTRACT

An information processing apparatus capable of communication with an external device that is connected through a network includes: a transmission unit that transmits a request, which is predefined, to the device which is predefined; and a determination unit that determines whether or not the request is to be transmitted to the device, in which the transmission unit transmits an advance notice request, which is predefined, to the device before transmitting the request, the determination unit determines whether or not the request is to be transmitted to the device, in accordance with a response result of the advance notice request, and the transmission unit transmits the request to the device, in a case where the determination unit determines that the request is to be transmitted to the device.

### BACKGROUND

### 1. Field

The present disclosure relates to an information processing apparatus, an information processing method, and an information processing program, and, more specifically, relates to an information processing apparatus, an information processing method, and an information processing program for transmitting a predetermined request to a device that is connected through a network.

### 2. Description of the Related Art

Conventionally, an information processing apparatus that transmits a predetermined request, a predetermined instruction, or the like to a device which is connected through a network and that acquires operation information or the like of the device is used.

In a case where such an information processing apparatus makes a request to a device having a function of shifting to a power saving state such as a sleep state, when the device to which the request is transmitted from the information processing apparatus is in the sleep state, the device does not receive the request in some cases.

In order to solve such a problem, conventionally, there is a disclosure (for example, refer to Japanese Unexamined Patent Application Publication No. 2006-39940) by which, before a search request is transmitted to a desired image processing apparatus on a network, a request for shifting the image processing apparatus from the sleep state to a normal state is transmitted.

However, in a conventional method by which a sleep release request for releasing a device on a network from the sleep state is transmitted before a predetermined request is transmitted to the device, in a case where the device as a transmission destination is in a response disabled state due to power interruption or the like, there is a possibility that both the sleep release request and the subsequent request are uselessly transmitted.

Moreover, since whether or not a device is in the response disabled state is confirmed when no response is returned after a request is transmitted to the device, in a case where requests are continuously transmitted to a plurality of devices, it is necessary to transmit, after a response from a device is received, a request to a next device. As a result, in the case where requests are transmitted to a plurality of devices, there is also a problem that transmission efficiency is lowered.

The disclosure is made in view of such circumstances and provides an information processing apparatus, an information processing method, and an information processing program for transmitting a predetermined request to a device, which is connected through a network, more efficiently than a conventional one.

### SUMMARY

According to the disclosure, there is provided an information processing apparatus capable of communication with an external device that is connected through a network, including: a transmission unit that transmits a request, which is predefined, to the device which is predefined; and a determination unit that determines whether or not the request is to be transmitted to the device, in which the transmission unit transmits an advance notice request, which is predefined, to the device before transmitting the request, the determination unit determines whether or not the request is to be transmitted to the device, in accordance with a response result of the advance notice request, and the transmission unit transmits the request to the device, in a case where the determination unit determines that the request is to be transmitted to the device.

Moreover, according to the disclosure, there is provided an information processing method by which a request that is predefined is transmitted to a device that is predefined and connected through a network, including: transmitting an advance notice request, which is predefined, to the device before transmitting the request; determining whether or not the request is to be transmitted to the device, in accordance with a response result of the advance notice request; and transmitting the request to the device, in a case where it is determined that the request is to be transmitted to the device.

Moreover, according to the disclosure, there is provided an information processing program causing a processor of an information processing apparatus that transmits a request, which is predefined, to a device that is predefined and connected through a network to execute: transmitting an advance notice request, which is predefined, to the device before transmitting the request; determining whether or not the request is to be transmitted to the device, in accordance with a response result of the advance notice request; and transmitting the request to the device, in a case where it is determined that the request is to be transmitted to the device.

### BRIEF DESCRIPTION OF THE DRAWINGS

FIG. 1 is an explanatory view illustrating a schematic configuration of a management system that includes an information processing apparatus of the disclosure;

FIG. 2 is a block diagram illustrating a schematic configuration of the information processing apparatus illustrated in FIG. 1;

FIG. 3 is a block diagram illustrating a schematic configuration of an image processing apparatus illustrated in FIG. 1;

FIG. 4 is an explanatory view illustrating an example of a management screen of the image processing apparatus, which is displayed on a display unit of the information processing apparatus of the disclosure;

FIG. 5 is a flowchart illustrating an outline of a procedure of setting for acquiring information of an image processing apparatus and for transmitting an advance notice request, in the information processing apparatus illustrated in FIG. 1;

FIG. 6 is an explanatory view illustrating an example of a setting screen for acquiring information of an image processing apparatus and for an advance notice request, which is displayed on the display unit of the information processing apparatus illustrated in FIG. 1;

FIG. 7 is a flowchart illustrating an outline of a procedure of acquiring information of an image processing apparatus by the information processing apparatus illustrated in FIG. 1; and

FIG. 8 is a flowchart illustrating details of a part of the procedure of acquiring information of an image processing apparatus, which is illustrated in FIG. 7.

### DESCRIPTION OF THE EMBODIMENTS

As described above, (1) an information processing apparatus according to the disclosure is an information processing apparatus capable of communication with an external device that is connected through a network, including: a transmission unit that transmits a request, which is predefined, to the device which is predefined; and a determination unit that determines whether or not the request is to be transmitted to the device, in which the transmission unit transmits an advance notice request, which is predefined, to the device before transmitting the request, the determination unit determines whether or not the request is to be transmitted to the device, in accordance with a response result of the advance notice request, and the transmission unit transmits the request to the device, in a case where the determination unit determines that the request is to be transmitted to the device.

Moreover, an information processing method according to the disclosure is an information processing method by which a request that is predefined is transmitted to a device that is predefined and connected through a network, including: transmitting an advance notice request, which is predefined, to the device before transmitting the request; determining whether or not the request is to be transmitted to the device, in accordance with a response result of the advance notice request; and transmitting the request to the device, in a case where it is determined that the request is to be transmitted to the device.

Moreover, an information processing program according to the disclosure is an information processing program causing a processor of an information processing apparatus that transmits a request, which is predefined, to a device that is predefined and connected through a network to execute: transmitting an advance notice request, which is predefined, to the device before transmitting the request; determining whether or not the request is to be transmitted to the device, in accordance with a response result of the advance notice request; and transmitting the request to the device, in a case where it is determined that the request is to be transmitted to the device.

In the disclosure, an “external device” is a device examples of which include an image processing apparatus such as a personal computer (PC), a scanner, an electronic blackboard, a television, or a DVD recorder, and an image forming apparatus such as a printer.

A “predefined request” is a predetermined request to be transmitted to an external device, and an example thereof includes a request to be transmitted for acquiring an operation information of the external device.

A “predefined advance notice request” is a request to be transmitted to an external device before a request is transmitted to the device, and whether or not the request is to be transmitted to the device is determined in accordance with a response result of the advance notice request.

Note that, a difference between a conventional sleep release request and the advance notice request of the disclosure lies in that, while the conventional sleep release request is transmitted only for releasing a sleep state of a device, the advance notice request of the disclosure enables, in addition to sleep releasing, determination as to whether or not to transmit a predefined request, which is made in accordance with a response result of the advance notice request, that is, enables suppression of a useless request to a device whose response may not be obtained due to a power interruption or the like even when the request is transmitted.

In Embodiment 1, a “transmission unit” of the disclosure is achieved by cooperation of a control unit 10 and a communication unit 13. Moreover, a “determination unit” of the disclosure is achieved by the control unit 10.

Further, desirable aspects of the disclosure will be described.

(2) In the information processing apparatus according to the disclosure, in a case where there is no response within a predefined response time after the request is transmitted to the device, the transmission unit may shift to processing of transmitting the request to another device.

Thereby, it is possible to achieve an information processing apparatus that, in the case where there is no response within the predetermined response time, since the device is more likely to be in a response disable state due to power interruption or the like, immediately shifts to transmission of the advance notice request to another device and thereby transmits, to a device which is connected through a network, a predetermined request more efficiently than a conventional one.

The “predefined response time” is set, for example, on the basis of a time from when the advance notice request is transmitted until when a device that has been in a power saving state recovers from the power saving state upon reception of the advance notice request and sends a response to the information processing apparatus. A standard response time is about 60 seconds.

The “processing of transmitting the request to another device” is a series of processing in which, after the advance notice request is transmitted to another device, in accordance with a response result thereto, the determination unit determines whether or not the request is to be transmitted, and in a case where the determination unit determines that the request is to be transmitted, the advance notice request and the request are transmitted to the another device.

(3) In the information processing apparatus according to the disclosure, a setting reception unit that receives transmission setting of the advance notice request may be further included, and the transmission setting may include setting as to whether or not the advance notice request is to be transmitted.

Thereby, it is possible to freely set the transmission setting of the advance notice request, which includes the setting as to whether or not the advance notice request is to be transmitted, thus making it possible to achieve an information processing apparatus that transmits, to a device which is connected through a network, a predetermined request more efficiently than a conventional one.

(4) In the information processing apparatus according to the disclosure, the transmission setting of the advance notice request may include setting of a transmission time and the number of times of transmission of the advance notice request.

Thereby, it is possible to freely set the transmission time and the number of times of transmission of the advance notice request, thus making it possible to achieve an information processing apparatus that transmits, to a device which is connected through a network, a predetermined request more efficiently than a conventional one.

(5) In the information processing apparatus according to the disclosure, the transmission unit may perform the transmission by deciding a transmission timing of the advance notice request on a basis of the transmission time and the number of times of transmission.

Thereby, the transmission timing of the advance notice request is automatically decided on the basis of the transmission time and the number of times of transmission that are set, so that it is possible to achieve an information processing apparatus that transmits, to a device which is connected through a network, a predetermined request more efficiently than a conventional one.

(6) In the information processing apparatus according to the disclosure, the setting reception unit may sort devices into groups and receive the transmission setting of the advance notice request for each of the groups.

Thereby, the transmission setting of the devices is received for each of the set groups, so that it is possible to achieve an information processing apparatus that transmits, to a device which is connected through a network, a predetermined request more efficiently than a conventional one.

Hereinafter, the disclosure will be described more specifically with reference to drawings. Note that, description below is an exemplification in all aspects, and should not be interpreted to limit the disclosure.

### Embodiment 1

### <Schematic Configuration of Management System 100>

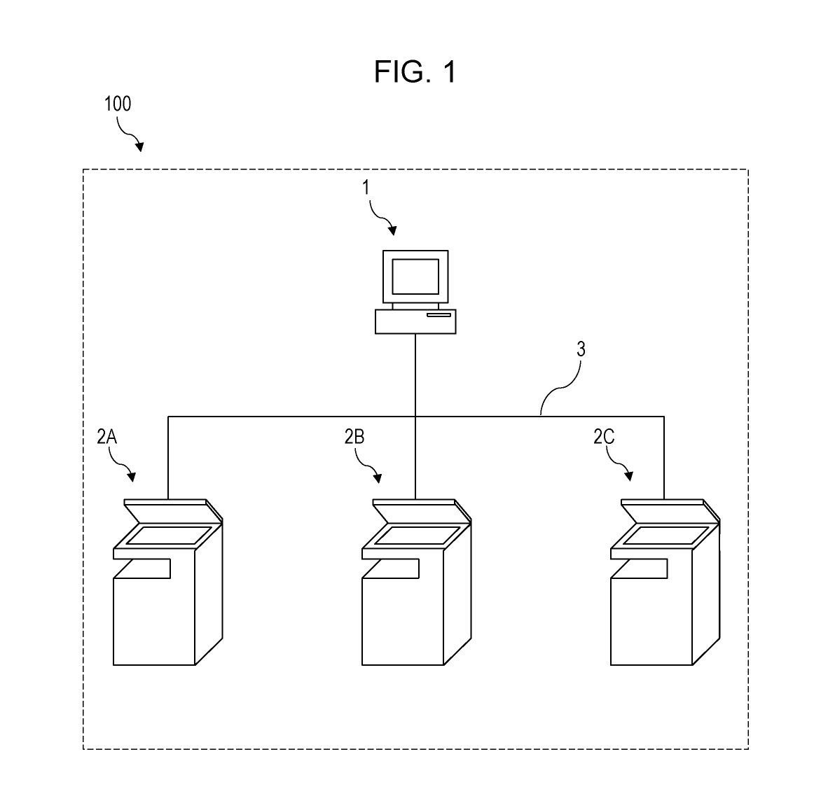

A configuration of a management system 100 that includes an information processing apparatus 1 of the disclosure and image processing apparatuses 2A to 2C as an example of devices of the disclosure will be described with reference to FIG. 1.

FIG. 1 is an explanatory view illustrating a schematic configuration of the management system 100 that includes the information processing apparatus 1 of the disclosure.

As illustrated in FIG. 1, the management system 100 of the disclosure is composed of the information processing apparatus 1, the image processing apparatuses 2A to 2C (hereinafter, collectively referred to as image processing apparatuses 2), and a network 3.

The information processing apparatus 1 is an apparatus, such as a host server, which acquires and manages operation information of the image processing apparatuses 2 that are connected through the network 3.

The information processing apparatus 1 updates the operation information by periodically acquiring the operation information from each of the image processing apparatuses 2.

The image processing apparatus 2 is an apparatus, such as an MFP (Multifunction Peripheral) that has a printer function and a scanner function, which processes image data generated by reading an original document and outputs the resultant.

The network 3 is a network, such as an intracompany network, which connects the information processing apparatus 1 and the image processing apparatuses 2.

Any network of a LAN, a wide area network (WAN) such as the Internet, a private communication line, or the like may be used as the network 3.

### <Schematic Configuration of Information Processing Apparatus 1>

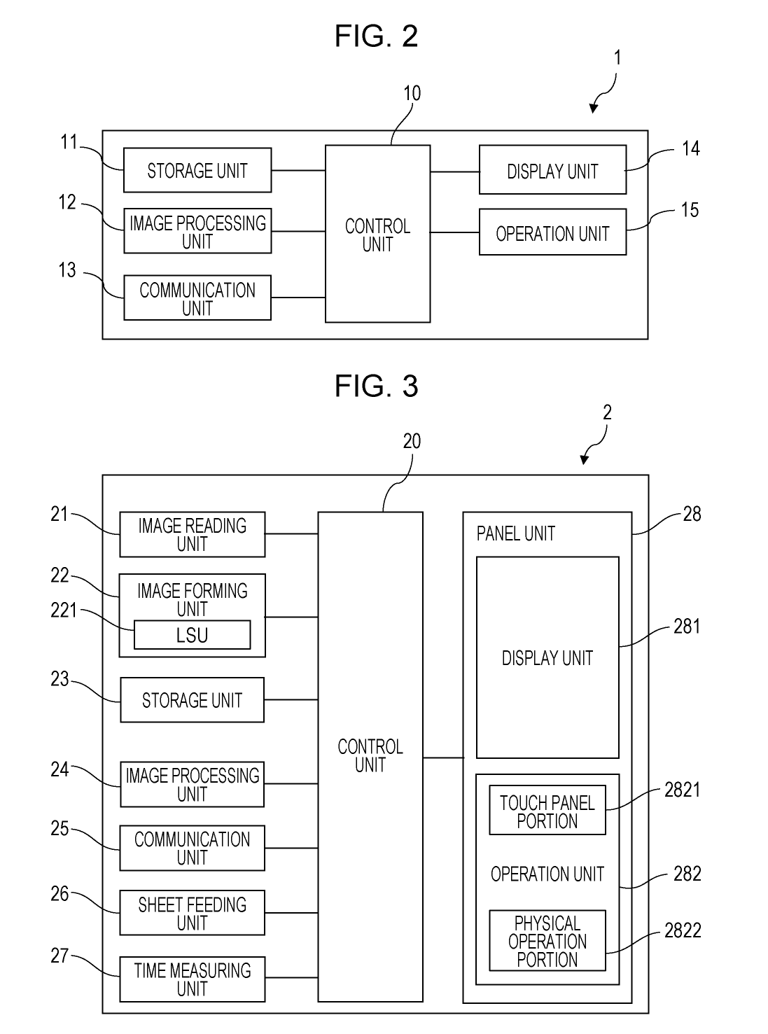

Next, a schematic configuration of the information processing apparatus 1 will be described with reference to FIG. 2.

FIG. 2 is a block diagram illustrating the schematic configuration of the information processing apparatus 1 illustrated in FIG. 1.

As illustrated in FIG. 2, the information processing apparatus 1 of the disclosure includes the control unit 10, a storage unit 11, an image processing unit 12, the communication unit 13, a display unit 14, and an operation unit 15.

Hereinafter, components of the information processing apparatus 1 will be described.

The control unit 10 is a unit that controls an operation of each component of the information processing apparatus 1, and is achieved by a microcomputer that is mainly composed of a CPU, a ROM, a RAM, an I/O controller, a timer, and the like. The control unit 10 is a circuit that mainly includes the CPU or a microprocessor. The control unit 10 organically operates each hardware on the basis of a control program, which is stored in the ROM or the like in advance, to execute a function of, for example, determining whether or not to transmit an advance notice request of the disclosure described later.

Note that, as a peripheral circuit, an ASIC (Application Specific Integrated Circuit) that is an integrated circuit which is designed and manufactured for a specific purpose or a circuit that has another calculation function may be included.

The storage unit 11 is an element or a storage medium that stores information which is necessary for realizing various functions of the information processing apparatus 1, a control program, or the like. For example, a semiconductor element such as a RAM or a ROM or a storage medium such as a hard disk, a flash storage unit, or an SSD is used therefor.

Note that, a program and data may be held in different devices in such a manner that an area for holding the data is configured in a hard disk drive and an area for holding the program is configured in a flash storage unit.

The image processing unit 12 is a unit that applies processing to image data so as to be suitable for an output to the display unit 14, and also a unit that applies, in accordance with an instruction from the operation unit 15, processing to the image data so as to be suitable for an output with enlargement, reduction, or the like.

The communication unit 13 is a unit that performs communication with a device such as the external image processing apparatus 2 through the network 3 and receives various kinds of information such as an operation state of the image processing apparatus 2.

The display unit 14 is a unit that displays various kinds of information. The display unit 14 is constituted by, for example, a CRT display, a liquid crystal display, an EL display, or the like, and is a display device, such as a monitor or a line display, which displays electronic data such as a processing state of an operating system or application software. The control unit 10 performs display of an operation or a state of the information processing apparatus 1 through the display unit 14.

The operation unit 15 is an interface by which an operation of the information processing apparatus 1 is performed. A user executes an instruction to the information processing apparatus 1 by operating the operation unit 15. The operation unit 15 may be operated by a physical key in which a plurality of keys are arrayed or may be operated by a touch panel provided on the display unit 14.

### <Schematic Configuration of Image Processing Apparatus 2>

Next, a schematic configuration of the image processing apparatus 2 will be described with reference to FIG. 3.

FIG. 3 is a block diagram illustrating the schematic configuration of the image processing apparatus 2 illustrated in FIG. 1.

As illustrated in FIG. 3, the image processing apparatus 2 of the disclosure includes a control unit 20, an image reading unit 21, an image forming unit 22, a storage unit 23, an image processing unit 24, a communication unit 25, a sheet feeding unit 26, a time measuring unit 27, and a panel unit 28.

Hereinafter, components of the image processing apparatus 2 will be described.

Note that, since the control unit 20, the storage unit 23, the image processing unit 24, the communication unit 25, and a display unit 281 respectively have configurations similar to those of the control unit 10, the storage unit 11, the image processing unit 12, the communication unit 13, and the display unit 14, which are illustrated in FIG. 2, description thereof will be omitted.

The image reading unit 21 is a unit that detects and reads an original document stacked on an original document table or an original document conveyed from an original document tray and that performs conversion into an appropriate electric signal to generate image data.

The image forming unit 22 is a unit that prints and outputs, on a sheet, the image data which is generated by the image reading unit 21 and processed by the image processing unit 24, and includes an LSU 221.

The LSU 221 is a device that radiates laser light corresponding to image information composed of a digital signal acquired by the image reading unit 21 onto a surface of a photosensitive drum in a charged state and thereby forms an electrostatic latent image.

The sheet feeding unit 26 is a unit that conveys, to the image forming unit 22, a sheet which is stored in a sheet feeding cassette or a manual feeding tray.

The time measuring unit 27 is a unit that measures time, and acquires time by, for example, a built-in clock or the network 3.

The panel unit 28 is a unit that includes a liquid crystal display, and includes the display unit 281 and an operation unit 282.

The operation unit 282 is an interface by which the image processing apparatus 2 is operated and is a unit which includes a touch panel portion 2821 and a physical operation portion 2822 and through which an instruction from a user is received.

The image processing apparatus 2 executes a job of scanning, printing, copying, transmission of an image, or the like on the basis of the instruction from the user, which is received through the operation unit 282 or the communication unit 25.

The touch panel portion 2821 is configured by a display panel constituted by a liquid crystal panel or the like and a touch panel of an electrostatic capacitive system or the like, which is arranged on the display panel in an overlapping manner and detects a position which is touched with a finger.

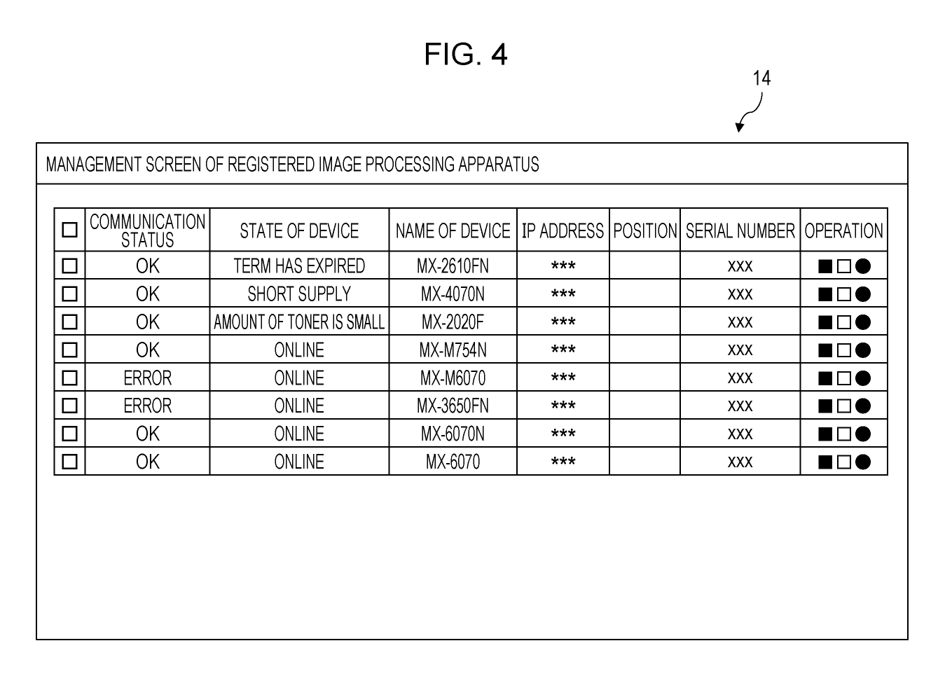

Next, a management screen of the image processing apparatus 2, which is displayed on the display unit 14 of the information processing apparatus 1 of the disclosure, will be described with reference to FIG. 4.

FIG. 4 is an explanatory view illustrating an example of the management screen of the image processing apparatus 2, which is displayed on the display unit 14 of the information processing apparatus 1 of the disclosure.

As illustrated in FIG. 4, the management screen of the image processing apparatus 2 which is registered in advance is displayed on the display unit 14 of the information processing apparatus 1.

In the example of FIG. 4, items of “communication status”, “state of device”, “name of device”, “IP address”, “position”, “serial number”, and “operation” are displayed on the management screen.

Note that, an item other than the items illustrated in the example of FIG. 4 may be included in the management screen.

Hereinafter, the items of FIG. 4 will be described.

“Communication status” indicates a status of communication with the image processing apparatus 2, and “OK” indicates that the communication status is good and “error” indicates that the communication status is bad.

“State of device” indicates a state of the image processing apparatus 2.

For example, “term has expired” indicates that a term of service or the like has expired, “short supply” indicates that a sheet or the like is in short supply, and “amount of toner is small” indicates that a residual amount of toner is small. “Online” indicates that a state of the image processing apparatus 2 is good.

“Name of device” indicates a name of the image processing apparatus 2.

“IP address” indicates an IP address assigned to the image processing apparatus 2.

“Position” indicates a position of the image processing apparatus 2. Note that, in a case where the position of the image processing apparatus 2 is not input, a column of “position” may be left blank as illustrated in the example of FIG. 4.

“Serial number” indicates a serial number of the image processing apparatus 2.

Various operation icons for operating the image processing apparatus 2 are displayed as “operation”. A user is able to perform a predetermined operation with respect to the image processing apparatus 2 by clicking a corresponding operation icon.

The information processing apparatus 1 acquires operation information from the registered image processing apparatus 2 in accordance with a predefined schedule and thereby updates an operation status of the image processing apparatus 2.

### <Procedure of Setting Advance Notice Request in Information Processing Apparatus 1>

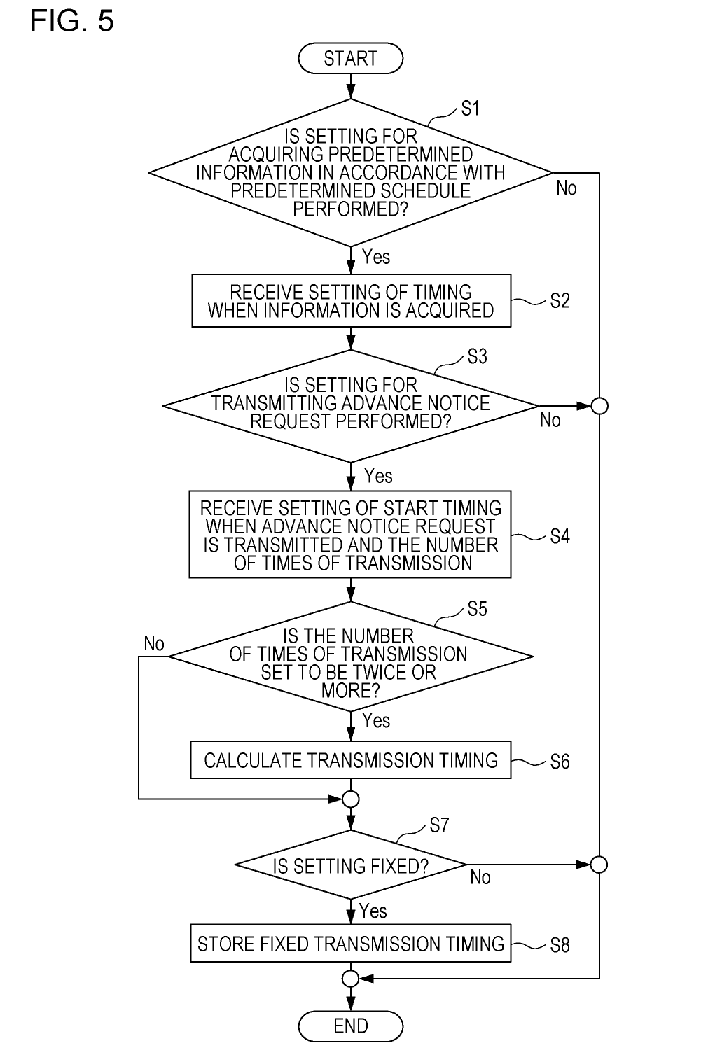

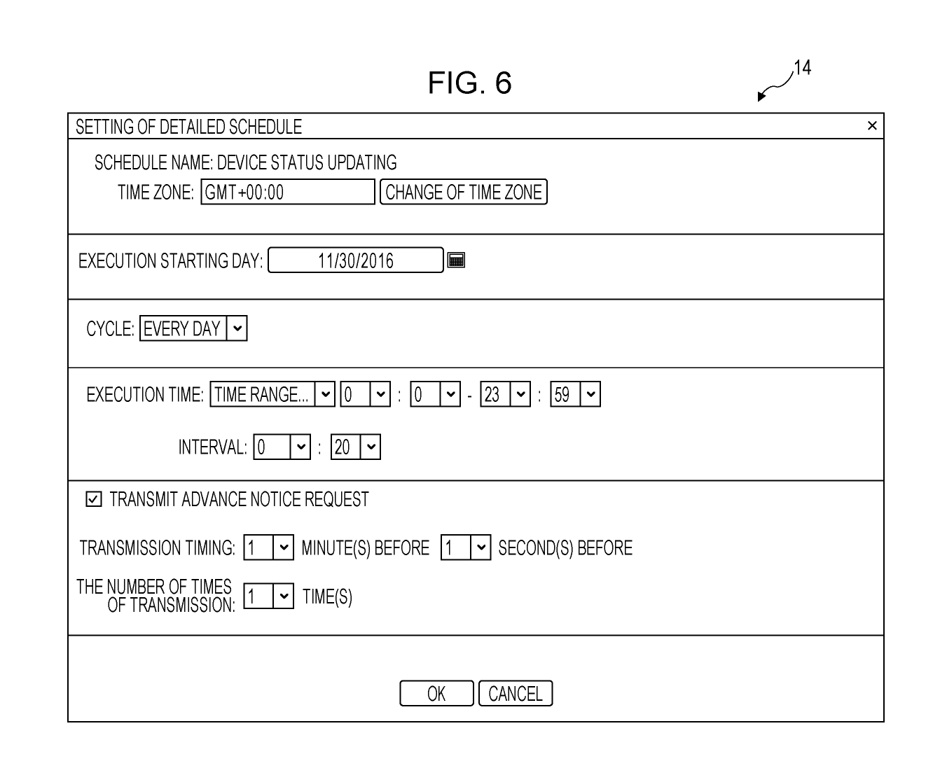

Next, a procedure of setting for acquiring information of the image processing apparatus 2 and for transmitting an advance notice request in the information processing apparatus 1 of the disclosure will be described with reference to FIGS. 5 and 6.

FIG. 5 is a flowchart illustrating an outline of the procedure of setting for acquiring information of the image processing apparatus 2 and for transmitting an advance notice request, in the information processing apparatus 1 illustrated in FIG. 1. FIG. 6 is an explanatory view illustrating an example of a setting screen for acquiring information of the image processing apparatus 2 and for an advance notice request, which is displayed on the display unit 14 of the information processing apparatus 1 illustrated in FIG. 1.

At step S1 of FIG. 5, the control unit 10 of the information processing apparatus 1 determines whether or not setting for acquiring predetermined information of the image processing apparatus 2 in accordance with a predefined schedule is performed (step S1).

Here, as illustrated in items of the setting screen in FIG. 6, a user is able to perform setting of “execution starting day”, “cycle”, “execution time”, and “interval” for acquiring the information.

When it is determined, at step S1, that the setting for acquiring the predetermined information in accordance with the predefined schedule is performed (when the determination at step S1 is Yes), at step S2, the control unit 10 receives setting of a timing when the information is acquired (step S2).

Thereafter, the control unit 10 performs determination at step S3 (step S3).

In the example of FIG. 6, for acquiring the information, “execution starting day” is set as Nov. 30, 2016, “cycle” is set as every day, “execution time” is set as 0 o'clock 0 minute to 23 o'clock 59 minutes, and “interval” is set as every 20 minutes.

On the other hand, when it is determined, at step S1, that the setting for acquiring the information in accordance with the predefined schedule is not set (when the determination at step S1 is No), the control unit 10 ends the setting processing.

Next, at step S3, the control unit 10 determines whether or not setting for transmitting an advance notice request is performed (step S3).

Here, as illustrated in FIG. 6, in a case where the advance notice request is transmitted, a user checks a check box of “transmit advance notice request”.

When the setting for transmitting an advance notice request is performed at step S3 (when the determination at step S3 is Yes), the control unit 10 receives, at step S4, setting of a start timing when the advance notice request is transmitted and the number of times of transmission (step S4).

After that, the control unit 10 performs determination at step S5 (step S5).

In the example of FIG. 6, 1 minute and 1 second before information acquisition is set as “transmission timing” of the advance notice request, and once is set as “the number of times of transmission”.

On the other hand, when the setting for transmitting the advance notice request is not performed (when the determination at step S3 is No), the control unit 10 ends the setting processing.

Next, at step S5, the control unit 10 determines whether or not the number of times of transmission of the advance notice request is set to be twice or more (step S5).

When the number of times of transmission of the advance notice request is set to be twice or more (when the determination at step S5 is Yes), the control unit 10 calculates a specific transmission timing at step S6 (step S6).

After that, the control unit 10 performs determination at step S7 (step S7).

For example, when 1 minute and 0 second before information acquisition is set as “transmission timing” of the advance notice request and three times is set as “the number of times of transmission”, the control unit 10 transmits the advance notice request once 60 seconds, 40 seconds, and 20 seconds before information acquisition.

Note that, a specific calculation method of the transmission timing is not limited to the above and the transmission timing may be calculated on the basis of a predefined calculation formula.

On the other hand, when the number of times of transmission of the advance notice request is set to be only once (when the determination at step S5 is No), the control unit 10 determines, at step S7, whether or not the setting is fixed (step S7).

Specifically, when an icon of “OK” at a lowermost part of the setting screen of FIG. 6 is pressed, the control unit 10 determines that the setting is fixed, while the control unit 10 determines that the setting is not fixed, when an icon of “cancel” is pressed.

When the setting is fixed (when the determination at step S7 is Yes), the control unit 10 causes the storage unit 11 to store the fixed transmission timing at step S8 (step S8).

On the other hand, when the setting is not fixed (when the determination at step S7 is No), the control unit 10 ends the setting processing.

### <Procedure of Acquiring Information of Image Processing Apparatus 2 by Information Processing Apparatus 1>

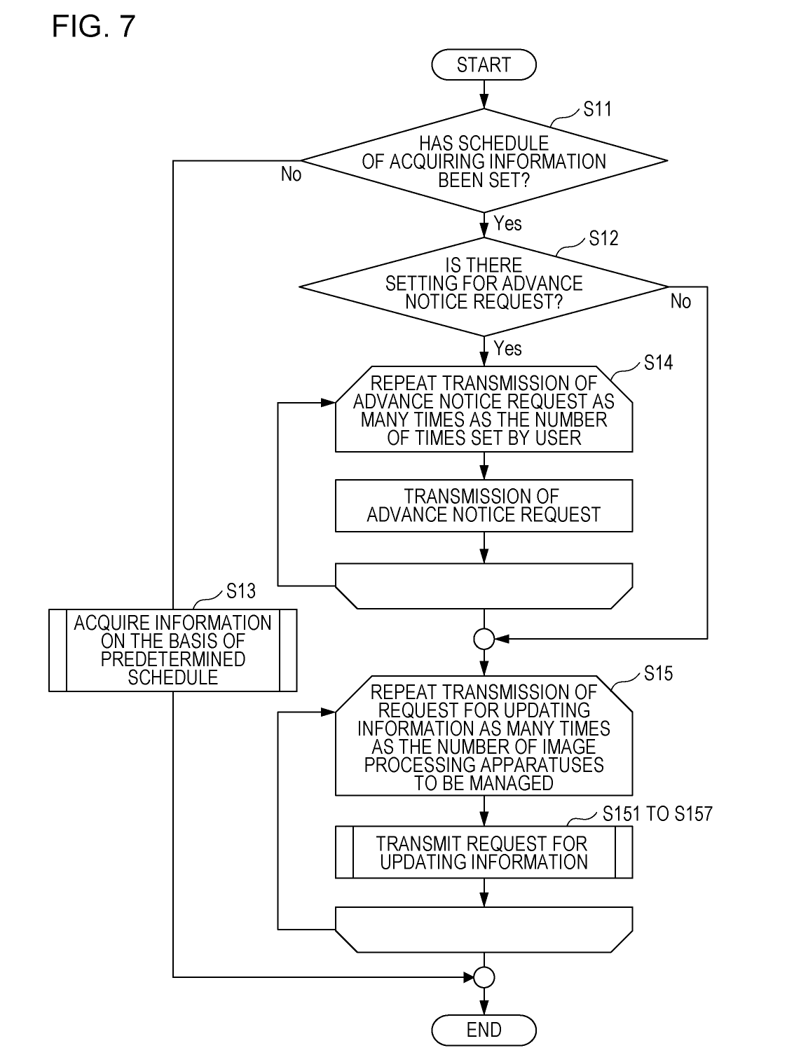

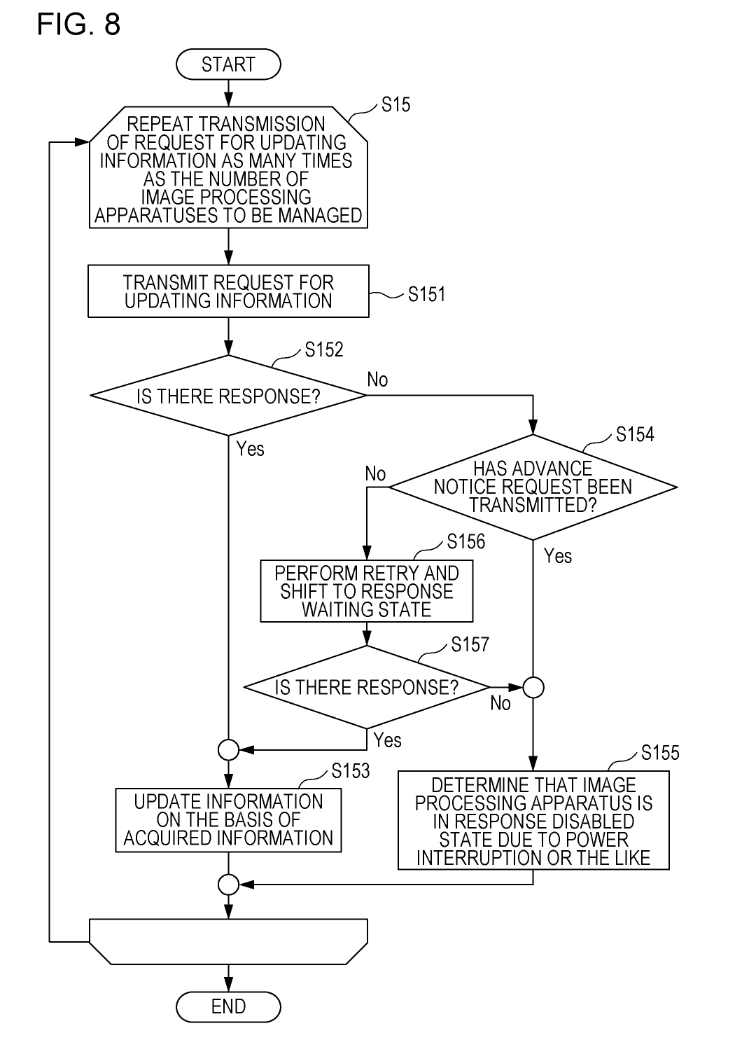

Next, an outline of a procedure of acquiring information of the image processing apparatus 2 by the information processing apparatus 1 of the disclosure will be described with reference to FIGS. 7 and 8.

FIG. 7 is a flowchart illustrating the outline of the procedure of acquiring information of the image processing apparatus 2 by the information processing apparatus 1 illustrated in FIG. 1.

At step S11 of FIG. 7, the control unit 10 of the information processing apparatus 1 determines whether or not a schedule of acquiring the information has been set (step S11).

When the schedule of acquiring the information has been set (when the determination at step S11 is Yes), the control unit 10 performs determination at step S12 (step S12).

On the other hand, when the schedule of acquiring the information has not been set (when the determination at step S11 is No), at step S13, the control unit 10 acquires the information of the image processing apparatus 2 on the basis of a predefined default schedule (step S13), and then ends the processing of acquiring the information.

Note that, when the schedule has not been set, the information acquisition may be manually executed, and, in this case, the information of the image processing apparatus 2 may be acquired when the information acquisition is manually executed.

Next, at step S12, the control unit 10 determines whether or not there is setting for the advance notice request (step S12).

When there is the setting for the advance notice request (when the determination at step S12 is Yes), the control unit 10 repeats, at step S14, transmission of the advance notice request as many times as the number of times set by a user (step S14).

Thereafter, the control unit 10 performs processing at step S15 (step S15).

On the other hand, when there is no setting for the advance notice request (when the determination at step S12 is No), the control unit 10 performs processing at step S15 (step S15).

Next, at step S15, the control unit 10 transmits requests for updating information as many as the number of image processing apparatuses 2 to be managed (step S15).

After that, the control unit 10 ends the processing of acquiring the information.

FIG. 8 is a flowchart illustrating details of a part of the procedure of acquiring information of the image processing apparatus 2, which is illustrated in FIG. 7.

At step S151 of FIG. 8, the control unit 10 transmits a request for updating information to the image processing apparatus 2 to be managed (step S151).

Subsequently, at step S152, the control unit 10 determines whether or not there is a response from the image processing apparatus 2 (step S152).

When there is a response from the image processing apparatus 2 (when the determination at step S152 is Yes), the control unit 10 updates information on the basis of the acquired information at step S153 (step S153).

On the other hand, when there is no response from the image processing apparatus 2 (when the determination at step S152 is No), the control unit 10 determines, at step S154, whether or not the advance notice request has been transmitted (step S154).

When the advance notice request has been transmitted (when the determination at step S154 is Yes), the control unit 10 determines, at step S155, that the image processing apparatus 2 is in a response disabled state due to power interruption or the like (step S155).

On the other hand, when the advance notice request has not been transmitted (when the determination at step S154 is No), at step S156, the control unit 10 performs retry with respect to the image processing apparatus 2 and shifts to a response waiting state (step S156).

At subsequent step S157, the control unit 10 determines whether or not there is a response from the image processing apparatus 2 (step S157).

When there is a response from the image processing apparatus 2 (when the determination at step S157 is Yes), the control unit 10 performs the processing at step S153 (step S153).

On the other hand, when there is no response from the image processing apparatus 2 (when the determination at step S157 is No), the control unit 10 performs the processing at step S155 (step S155).

Note that, at step S156, retry may be repeated twice or more, which is the predefined number of times, until a response is given from the image processing apparatus 2.

When the processing at steps S151 to S157 is completed with respect to all the image processing apparatuses 2 to be managed, the control unit 10 ends the processing.

In this manner, the advance notice request is transmitted to each of the image processing apparatuses 2 that are connected through the network 3, so that the information processing apparatus 1 that performs updating more efficiently than a conventional one is able to be achieved.

### Embodiment 2

As Embodiment 2, the image processing apparatuses 2 to be managed may be sorted into groups and the processing of transmitting the advance notice request may be performed with setting which is different for each group.

For example, processing in which, for a group of the image processing apparatuses 2 which tend to require a longer time to recover from a power saving state than a normal one, transmission is performed by setting a transmission timing of the advance notice request to be earlier than a normal one is considered.

As a result, with respect to the image processing apparatuses 2, it is possible to perform the processing of transmitting the advance notice request with setting which is different for each group, so that the information processing apparatus 1 that efficiently performs updating in accordance with characteristics of the image processing apparatuses 2 is able to be achieved.

### Embodiment 3

As Embodiment 3, the processing in FIGS. 7 and 8 may be performed to a plurality of image processing apparatuses 2 in parallel.

For example, in a case of the information processing apparatus 1 that is able to perform parallel processing for 20 devices, processing of transmitting the advance notice request and the request for updating information is performed in parallel for the 20 image processing apparatuses 2 to be managed.

As a result, processing of transmitting the advance notice request and the request for updating information is performed as parallel processing, so that the information processing apparatus 1 that performs updating more efficiently than a conventional one with respect to the image processing apparatuses 2 that are connected through the network 3 is able to be achieved.

### Embodiment 4

As Embodiment 4, a result of transmitting the advance notice request and the request for updating information with respect to the image processing apparatuses 2 in past may be stored in the storage unit 11, and an order of the image processing apparatuses 2, in which the advance notice request and the request for updating information are to be transmitted, may be decided on the basis of the transmission result.

For example, it is also possible to transmit the advance notice request preferentially to the image processing apparatus 2 that has been delayed in response in past due to the power saving state.

As a result, the processing of transmitting the advance notice request is performed in accordance with the order decided on the basis of the past transmission result, so that the information processing apparatus 1 that performs updating more efficiently than a conventional one with respect to the image processing apparatuses 2 that are connected through the network 3 is able to be achieved.

### Embodiment 5

As Embodiment 5, transmission may be performed by deciding a transmission time and the number of times of transmission on the basis of a past response result.

As a result, an appropriate timing of transmitting the advance notice request is decided on the basis of the past response result, so that the information processing apparatus 1 that performs updating more efficiently than a conventional one with respect to the image processing apparatuses 2 that are connected through the network 3 is able to be achieved.

The desirable aspects of the disclosure also include a combination of any ones of the above-described plurality of aspects.

In addition to the aforementioned embodiments, there may be various modified examples of the disclosure. Such modified examples should not be interpreted to be out of the scope of the disclosure. The disclosure should encompass meanings equivalent to the scope of the claims and all the modifications within the scope.

The present disclosure contains subject matter related to that disclosed in Japanese Priority Patent Application JP 2017-217344 filed in the Japan Patent Office on Nov. 10, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus capable of communication with an external device that is connected through a network, the information processing apparatus comprising:
a transmission unit that transmits a request, which is predefined, to the device which is predefined; and a determination unit that determines whether or not the request is to be transmitted to the device, wherein
the transmission unit transmits an advance notice request, which is predefined, to the device before transmitting the request,
the determination unit determines whether or not the request is to be transmitted to the device, in accordance with a response result of the advance notice request, and
the transmission unit transmits the request to the device, in a case where the determination unit determines that the request is to be transmitted to the device.

2. The information processing apparatus according to claim 1, wherein, in a case where there is no response within a predefined response time after the request is transmitted to the device, the transmission unit shifts to processing of transmitting the request to another device.

3. The information processing apparatus according to claim 1, further comprising
a setting reception unit that receives transmission setting of the advance notice request, wherein
the transmission setting includes setting as to whether or not the advance notice request is to be transmitted.

4. The information processing apparatus according to claim 3, wherein the transmission setting of the advance notice request includes setting of a transmission time and the number of times of transmission of the advance notice request.

5. The information processing apparatus according to claim 4, wherein the transmission unit performs the transmission by deciding a transmission timing of the advance notice request on a basis of the transmission time and the number of times of transmission.

6. The information processing apparatus according to claim 3, wherein the setting reception unit sorts devices into groups and receives the transmission setting of the advance notice request for each of the groups.

7. An information processing method by which a request that is predefined is transmitted to a device that is predefined and connected through a network, the information processing method comprising:
transmitting an advance notice request, which is predefined, to the device before transmitting the request;
determining whether or not the request is to be transmitted to the device, in accordance with a response result of the advance notice request; and
transmitting the request to the device, in a case where it is determined that the request is to be transmitted to the device.

8. An information processing program causing a processor of an information processing apparatus that transmits a request, which is predefined, to a device that is predefined and connected through a network to execute:
transmitting an advance notice request, which is predefined, to the device before transmitting the request;
determining whether or not the request is to be transmitted to the device, in accordance with a response result of the advance notice request; and
transmitting the request to the device, in a case where it is determined that the request is to be transmitted to the device.
